(19) United States
(12) Patent Application Publication
(10) Pub. No.: US 2014/0363996 A1
(43) Pub. Date: Dec. 11, 2014

(54) ANTI-ROTATION DEVICE FOR ELECTRICAL CONNECTORS

(71) Applicant: Alcatel-Lucent USA Inc., Murray Hill, NJ (US)

(72) Inventors: Ray C. Mitchell, Lake Hiawatha, NJ (US); Jinchul D. Park, Montville, NJ (US)

(21) Appl. No.: 13/912,278

(22) Filed: Jun. 7, 2013

(51) Int. Cl. H01R 13/622

(52) U.S. Cl. CPC H01R 13/622
USPC 439/339

(57) ABSTRACT

In one embodiment, an anti-rotation device is designed to prevent de-coupling of an electrical connector pair. The connector pair includes (i) a first electrical connector having a barrel with male threads formed thereon and (ii) a second electrical connector having a nut with female threads formed therein that mate with the male threads of the first connector. The anti-rotation device includes a barrel-locking portion connected by an interconnecting portion to a nut-locking portion. The barrel-locking portion engages the barrel of the first electrical connector to prevent rotation of the anti-rotation device circumferentially around the barrel. The nut-locking portion engages the nut of the second electrical connector to prevent the nut from rotating and backing out. The anti-rotation device inhibits rotation of the nut relative to the barrel, thereby preventing de-coupling of the second electrical connector from the first electrical connector.

### BACKGROUND

1. Field of the Invention

The present invention relates to electrical connectors, and, more specifically but not exclusively, preventing de-coupling of electrical connectors.

2. Description of the Related Art

In radio-frequency (RF) coaxial connector pairs that employ a hexagonal (hex) nut to secure one connector of the pair to the other, the hex nut may be turned using a controlled metered tool until a specified torque value is reached. For example, in SMA-type connectors, the specified torque value may range from 8-10 inch-pounds, which is slightly above the torque obtainable by the human hand. Unfortunately, even when the specified torque value is applied to the hex nut, stress, thermal shock, and vibration due to, for example, shipping of the mated connector pair, can cause the hex nut to back out, thereby losing the specified torque value. This, in turn, can jeopardize the proper electrical coupling of the connectors in a connector pair.

To prevent electrical de-coupling, connector pairs having higher specified torque values can be used. However, connector pairs having higher specified torque values are typically more expensive than connector pairs having lower specified torque values. Therefore, using connector pairs having higher specified torque values is disadvantageous because such connector pairs increase costs. These costs can be greatly magnified in applications that employ a large number of connector pairs.

### SUMMARY

In one embodiment, the present invention is an anti-rotation device configured to prevent de-coupling of an electrical connector pair that comprises (i) a first electrical connector having a barrel with male threads formed thereon and (ii) a second electrical connector having a nut with female threads formed therein configured to mate with the male threads of the first connector. The anti-rotation device comprises a barrel-locking portion, a nut-locking portion, and an interconnecting portion. The barrel-locking portion is configured to engage the barrel of the first electrical connector of the connector pair. The nut-locking portion is configured to engage the nut of the second electrical connector of the connector pair. The interconnecting portion interconnects the barrel-locking portion and the nut-locking portion. The anti-rotation device inhibits rotation of the nut relative to the barrel, thereby preventing de-coupling of the second electrical connector from the first electrical connector.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 shows a side view of one implementation of a conventional radio-frequency (RF) coaxial connector pair;

FIG. 2 shows end views of three different implementations of the first connector in FIG. 1;

FIG. 3 shows an end view of one implementation of the second connector in FIG. 1;

FIG. 4 shows a perspective view of an anti-rotation device according to one embodiment of the present disclosure;

FIG. 5 shows a perspective view of the anti-rotation device of FIG. 4 installed onto the first connector of FIG. 1;

FIG. 6 shows a side view of the anti-rotation device FIG. 4 installed onto the first connector of FIG. 1, which is connected to the second connector of FIG. 1;

FIG. 7 shows a side view of the anti-rotation device of FIG. 4 installed onto the first and second connectors of FIG. 1;

FIG. 8 shows a section view of the anti-rotation device of FIG. 4 installed onto the first and second connectors of FIG. 1 as in FIG. 7;

FIG. 9 shows a perspective view of an anti-rotation device according to another embodiment of the present disclosure;

FIG. 10 shows a side view of the anti-rotation device of FIG. 9 installed onto the first and second connectors of FIG. 1;

FIG. 11 shows a side view of an anti-rotation device according to yet another embodiment of the present disclosure;

FIG. 12 shows a side view of a locking device usable in the anti-rotation device of FIG. 11 according to one embodiment of the disclosure;

FIG. 13 shows an end view of the locking device of FIG. 11;

FIG. 14 shows a side view of the anti-rotation device of FIG. 11 installed onto the first and second connectors of FIG. 1;

FIG. 15 shows a perspective view of an anti-rotation device according to even yet another embodiment of the present disclosure; and

FIG. 16 shows a side view of the anti-rotation device of FIG. 15 installed onto the first and second connectors of FIG. 1.

### DETAILED DESCRIPTION

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

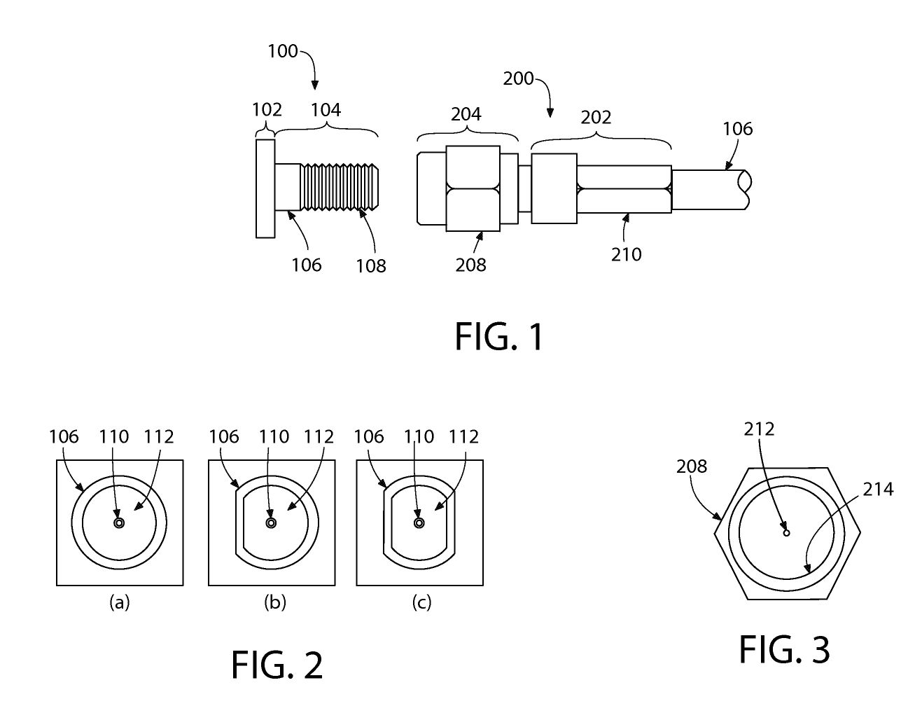

FIG. 1 shows a side view of one implementation of a conventional radio-frequency (RF) coaxial connector pair. The connector pair is a sub-miniature version A (SMA)-type connector pair having a first connector 100 and a corresponding second connector 200. First connector 100 comprises (i) a device-side portion 102 that is configured to mate either directly with an RF device (not shown) or with a cable leading to an RF device (also not shown) and (ii) a connector-side portion 104 having a barrel 106 with male threads 108 disposed thereon that are configured for mating with second connector 200. For simplicity, device-side portion 102 is shown as a box. However, one of ordinary skill in the art would recognize that device-side portion 102 may be configured in any of a number of different manners depending on the configuration of the RF device or cable to which device-side portion 102 is to be connected.

FIG. 2 shows end views of three different implementations of first connector 100. As shown in views (a)-(c), respectively, barrel 106 may have an annular cross-section, a “D-shaped” cross-section, or a “DD-shaped” cross-section. The “D” or “DD” shape may be used for grabbing when mating the connector pair and for preventing barrel 106 from rotating when barrel 106 is fed through a hole in a panel having a matching “D” or “DD” shape. In each implementation, barrel 106 is fabricated from a conducting metal that functions as an outer conductor. Further, in each implementation, an insulator 112 and a receptacle 110 are positioned within barrel 106. Receptacle 110, which is concentric with barrel 106, is formed from a conducting metal and is configured to electrically couple with an inner-conductor pin of second connector 200 (discussed below). Further, insulating material 112 is positioned within barrel 106 to keep receptacle 110 both physically and electrically isolated from barrel 106.

Referring back to FIG. 1, second connector 200 comprises a device-side portion 202 and a connector-side portion 204. In this implementation, device-side portion 202 has crimping collar 210 that is configured to mate with a coaxial cable 206 leading to an RF device (not shown). In alternative implementations, device-side portion 202 may be configured to mate directly with an RF device.

FIG. 3 shows an end view of one implementation of second connector 200. Connector-side portion 204 of second connector 200 comprises a hexagonal (hex) nut 208 configured for mating with first connector 100. Hex nut 208 is fabricated from a conducting metal that functions as an outer conductor. The inner surface 214 of hex nut 208 has female threads disposed thereon for mating with male threads 108 of first connector 100. An inner-conductor pin 212, which mates with receptacle 110 of first connector 100, is positioned within hex nut 208, such that pin 212 is substantially concentric with nut 208 (assuming pin 212 has not been bent).

To mate first connector 100 and second connector 200, second connector 200 is pressed against first connector 100 such that (i) pin 212 of second connector 200 enters receptacle 110 of first connector 100 and (ii) the female threads on surface 214 of second connector 200 abut male threads 108 of first connector 100. Hex nut 208 of second connector 200 is rotated such that the threads of second connector 200 engage threads 108 of first connector 100, thereby forcing pin 212 further into receptacle 110. To ensure proper mating for good electrical conduction, a specified torque value may be applied to hex nut 208 using a controlled metered tool.

Unfortunately, even when the specified torque value is applied to hex nut 208, stress, thermal shock, and vibration due to, for example, shipping of the mated connector pair, can cause hex nut 208 to back out, thereby losing the specified torque value. Instead of or in addition to implementing connector pairs having higher specified torque values, anti-rotation devices can be used to prevent hex nuts in the connector pairs, such as hex nut 208 in FIG. 1, from backing out. Such anti-rotation devices can be relatively simple, and the added costs of such devices can be lower than the added cost of upgrading to a connector pair having a higher specified torque value.

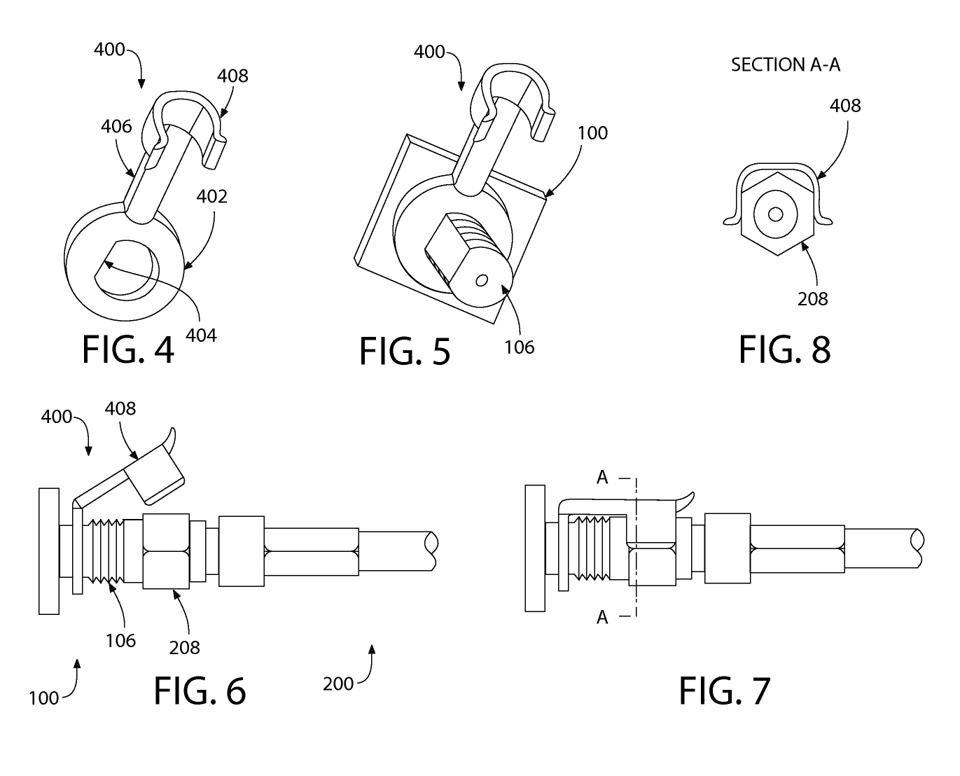

FIG. 4 shows a perspective view of an anti-rotation device 400 according to one embodiment of the present disclosure, and FIG. 5 shows a perspective view of anti-rotation device 400 installed on first connector 100 of FIG. 1. Anti-rotation device 400 comprises a barrel-locking portion 402 and a nut-locking portion 408 that is connected to band-locking portion 402 via an interconnecting portion 406, which in this embodiment is a flexible arm. Barrel-locking portion 402 has a ring-like shape with a “D-shaped” hole 404 formed therein. As shown in FIG. 5, barrel-locking portion 402 is mated with first connector 100 by sliding band-locking portion 402 over barrel 106, the cross-section of which is “D-shaped.” When device 400 is installed onto first connector 100, the “D-shapes” of hole 404 and barrel 106 prevent device 400 from rotating circumferentially around barrel 106. Note that, in alternative embodiments of the disclosure, hole 404 and band 106 may each have a shape, other than a “D-shape”, such as a “DD-shape”, that prevents device 400 from rotating.

FIG. 6 shows a side view of anti-rotation device 400 installed onto first connector 100, which is connected to second connector 200 of FIG. 1; FIG. 7 shows a side view of anti-rotation device 400 installed onto first and second connectors 100 and 200; and FIG. 8 shows a section view of anti-rotation device 400 installed onto first and second connectors 100 and 200 as in FIG. 7. As shown, flexible arm 406 is a flexible piece of material that allows nut-locking portion 408, which is a clip that is configured to engage with a hex nut 208, to be pressed down onto hex nut 208. After first and second connectors 100 and 200 are properly mated to each other by torqueing hex nut 208 to the specified torque value with anti-rotation device 400 installed as in FIG. 6, nut-locking portion 408 is pressed over hex nut 208 as in FIGS. 7 and 8, to prevent hex nut 208 from rotating and backing out. Device 400 can be manufactured out of any suitable material, such as a spring-like, flexible plastic or metal, the latter of which can enable device 400 to act as a secondary outer conductor between first connector 100 and second connector 200.

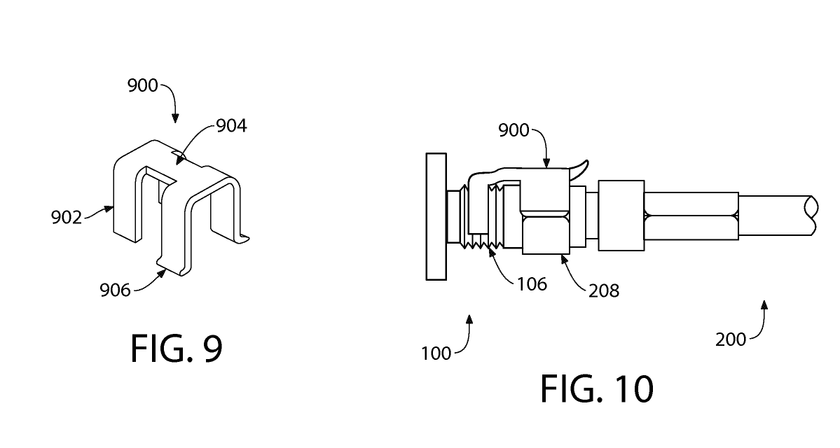

FIG. 9 shows a perspective view of an anti-rotation device 900 according to another embodiment of the present disclosure, and FIG. 10 shows a side view of anti-rotation device 900 installed onto first and second connectors 100 and 200 of FIG. 1. Anti-rotation device 900 comprises a nut-locking portion 906 that is the same as nut-locking portion 408 of device 400 in FIG. 4. Anti-rotation device 900 also comprises a barrel-locking portion 902 that is different from barrel-locking portion 402 of device 400. In particular, barrel-locking portion 902 is a clip that engages with barrel 106 of first connector 100 to prevent device 900 from rotating circumferentially around barrel 106. Nut-locking portion 906 and barrel-locking portion 902 are adjoined by an arm 904, which may be flexible like arm 406 of device 400 or may be rigid.

The configuration of device 900 allows device 900 to be installed and removed after first and second connectors 100 and 200 are mated to each other. This is in contrast to device 400, which must be installed onto first connector 100 before first and second connectors 100 and 200 are mated. Further, like device 400, device 900 may be constructed using any suitable material, such as plastic or metal, the latter of which can enable device 900 to act as a secondary outer conductor between first connector 100 and second connector 200.

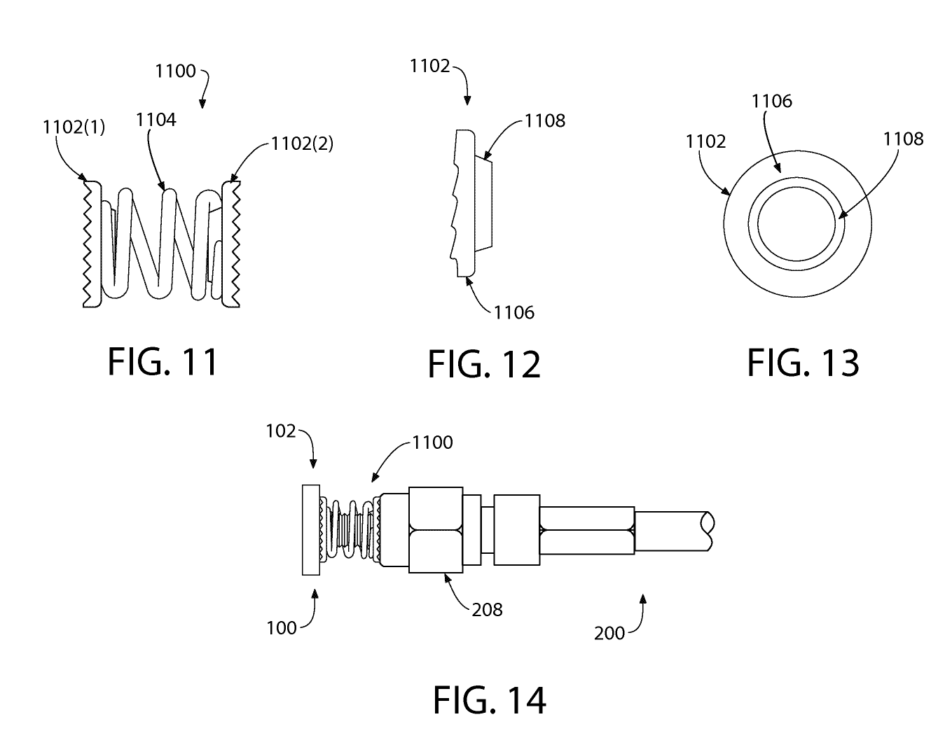

FIG. 11 shows a side view of an anti-rotation device 1100 according to yet another embodiment of the present disclosure. Device 1100 comprises a barrel-locking portion 1102(1), an interconnecting portion 1104, which in this case is a spring, and a nut-locking portion 1102(2). FIG. 12 shows a side view of a locking element 1102 according to one embodiment of the disclosure that may be used to implement each of barrel-locking portion 1102(1) and nut-locking portion 1102(2), and FIG. 13 shows an end view of locking element 1102. Locking element 1102 comprises a directional grip washer 1106 and a spring mount 1108, which is configured to mate with the interior diameter of spring 1104. As shown in FIG. 11, spring 1104 attaches to spring mount 1108 of each of barrel-locking portion 1102(1) and nut-locking portion 1102(2). Note that spring mount 1108 may mechanically attach to one or more of barrel-locking portion 1102(1) and nut-locking portion 1102(2) or spring mount 108 may be designed such that enough force is applied against barrel-locking portion 1102(1) and nut-locking portion 1102(2) to prevent them from rotating.

FIG. 14 shows a side view of anti-rotation device 1100 installed onto first and second connectors 100 and 200 of FIG. 1. When second connector 200 is mated with first connector 100, spring 1104 compresses, resulting in (i) friction between device-side portion 102 of first connector 100 and barrel-locking portion 1102(1) of device 1100 and (ii) friction between hex nut 208 and nut-locking portion 1102(2) of device 1100. This friction enables the directional grip washers 1106 of barrel-locking portion 1102(1) and nut-locking portion 1102(2) to grip device-side portion 102 and hex nut 208, respectively. Further, the orientation of the ridges of the directional grip washers 1106 of barrel-locking portion 1102(1) enables device 1100 to rotate circumferentially around barrel 106 (not labeled in FIG. 14) of first connector 100 in the installation direction of hex nut 208, but inhibits device 1100 from rotating in a direction that is opposite of the installation direction of hex nut 208 (i.e., in the removal direction).

Spring 1104 resists torsion thereby ensuring that, (i) when one of barrel-locking portion 1102(1) and nut-locking portion 1102(2) rotates circumferentially around barrel 106, the other rotates by a substantially equal amount, and (ii) when one of barrel-locking portion 1102(1) and nut-locking portion 1102(2) is inhibited from rotating, the other is also substantially prohibited from rotating. As a result of these characteristics of barrel-locking portion 1102(1), nut-locking portion 1102(2), and spring 1104, anti-rotation device 1100 prevents hex nut 208 from rotating circumferentially around barrel 106 in the removal direction (i.e., prevents hex nut 208 from backing out).

As shown in FIG. 13, the directional washer of locking device 1102 may have an annular shape, and need not have a “D-shape” or “DD-shape” to prevent de-torqueing of hex nut 208. As such, barrel 106 can be annular as in FIG. 2(a). However, in alternative embodiments of the disclosure, locking device 1102 may have a “D-shape” or a “DD-shape” depending on the shape of barrel 106. Further, embodiments of the disclosure are not limited to using directional grip washers. Alternative embodiments of the disclosure may be implemented using other types of washers that prevent rotation, including locking washers. In fact, when barrel 106 has a “D-shape” or a “DD-shape”, barrel-locking portion 1102(1) may be implemented with a flat, non-locking and non-directional washer that has a “D-shaped” or “DD-shaped” hole formed therein.

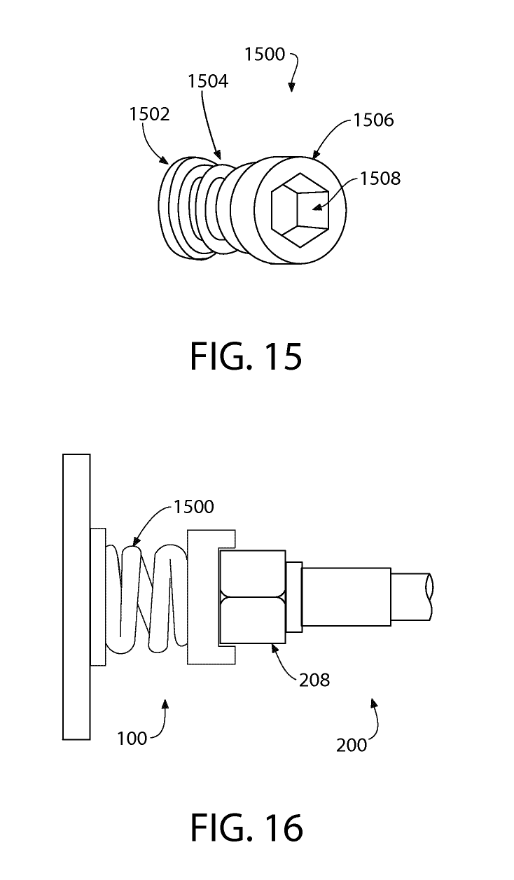

FIG. 15 shows a perspective view of an anti-rotation device 1500 according to even yet another embodiment of the present disclosure, and FIG. 16 shows a side view of anti-rotation device 1500 installed onto first and second connectors 100 and 200 of FIG. 1. Device 1500 comprises a barrel-locking portion 1502, an interconnecting portion 1504, and a nut-locking portion 1506. Barrel-locking portion 1502 may implemented in any of the manners described above in relation to barrel-locking portion 1102(1), and interconnecting portion 1504 may be implemented as a spring similar to spring 1104. Nut-locking portion 1506 has a cylindrical shape with a hex-shaped hole 1508 formed therein that is configured to receive and mate with hex nut 208 of second connector 200. Device 1500 works in a manner similar to that of device 1100 of FIG. 11; however, rather than using friction to prevent hex nut 208 from rotating, nut-locking portion 1506 engages with the six rectangular surfaces of hex nut 208 to prevent hex nut 208 from rotating.

Although anti-rotation devices of the present disclosure were described relative to their use with SMA-type connectors, embodiments of the disclosure are not so limited. Anti-rotation devices of the disclosure may be used with electrical connectors other than SMA-type connectors, including N-type connectors, and even non-coaxial connectors, such as connectors having multiple pin configurations and connectors that have a non-coaxial configuration.

Further, although anti-rotation devices of the present disclosure were described relative to their use with connectors having a hex-shaped nut, embodiments of the disclosure are not so limited. Anti-rotation devices of the disclosure may be used with nuts having other shapes, including but not limited to, cylindrical shapes having knurling formed on the outer curved surface of the nut.

It will be further understood that various changes in the details, materials, and arrangements of the parts which have been described and illustrated in order to explain the nature of this invention may be made by those skilled in the art without departing from the scope of the invention as expressed in the following claims. For example, although nut-locking portion 1506 of anti-rotation device 1500 of FIG. 15 was described as having a cylindrical shape, alternative embodiments of the disclosure may employ a nut-locking portion that has another shape, such as a cube. As another example, although anti-rotation devices 1100 and 1500 were shown as employing coil springs, alternative embodiments of the disclosure may employ other types of spring-like devices. For example, anti-rotation devices 1100 and 1500 may be implemented using a thick ring or gasket made of an elastomeric material or other material that has spring-like properties when compressed.

Yet further, it will be understood that various features of the embodiments discussed herein may be interchanged to create further embodiments. For instance, anti-rotation device 1500 of FIG. 15 may be implemented using barrel-locking portion 402 of FIG. 4 in lieu of nut-locking portion 1506, wherein barrel-locking portion 402 is modified to attach to spring 1504.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. An anti-rotation device configured to prevent de-coupling of an electrical connector pair comprising a first electrical connector having a barrel with male threads formed thereon and a second electrical connector having a nut with female threads formed therein configured to mate with the male threads of the first connector, wherein the anti-rotation device comprises:
a barrel-locking portion configured to engage the barrel of the first electrical connector of the connector pair;
a nut-locking portion configured to engage the nut of the second electrical connector of the connector pair; and
an interconnecting portion interconnecting the barrel-locking portion and the nut-locking portion, wherein the anti-rotation device inhibits rotation of the nut relative to the barrel, thereby preventing de-coupling of the second electrical connector from the first electrical connector.

2. The anti-rotation device of claim 1, wherein:
the barrel has a “D-shaped” or “DD-shaped” cross-section;
the barrel-locking portion has a corresponding “D-shaped” or “DD-shaped” hole formed therein, wherein the corresponding “D-shaped” or “DD-shaped” hole prevents the anti-rotation device from rotating circumferentially around the barrel of the first electrical connector.

3. The anti-rotation device of claim 2, wherein the nut-locking portion comprises a clip configured to engage with an outer surface of the nut of the second electrical connector to prevent the nut from rotating.

4. The anti-rotation device of claim 1, wherein the nut-locking portion comprises a clip configured to engage with an outer surface of the nut of the second electrical connector to prevent the nut from rotating.

5. The anti-rotation device of claim 1, wherein the barrel-locking portion comprises a clip configured to engage with an outer surface of the barrel of the first electrical connector to prevent the anti-rotation device from rotating circumferentially around the barrel of the first electrical connector.

6. The anti-rotation device of claim 5, wherein the nut-locking portion comprises a clip configured to engage with an outer surface of the nut of the second electrical connector to prevent the nut from rotating.

7. The anti-rotation device of claim 1, wherein the interconnecting portion comprises a spring positioned between the barrel-locking portion and the nut-locking portion, wherein:
the spring is configured to apply force to the barrel-locking portion to establish friction between the barrel-locking portion and the first electrical connector; and
the spring is configured to apply force to the nut-locking portion to establish friction between the nut-locking portion and the nut.

8. The anti-rotation device of claim 7, wherein the barrel-locking portion comprises a washer configured to prevent the anti-rotation device from rotating circumferentially around the barrel of the first electrical connector in a removal direction of the nut.

9. The anti-rotation device of claim 8, wherein the nut-locking portion comprises a washer configured to prevent the nut from rotating in a removal direction of the nut.

10. The anti-rotation device of claim 8, wherein the nut-locking portion has a hole formed therein configured to mate with an outer surface of the nut, wherein a shape of the hole prevents the nut from rotating.

11. The anti-rotation device of claim 1, wherein the nut-locking portion comprises a washer configured to prevent the nut from rotating in a removal direction of the nut.

12. The anti-rotation device of claim 1, wherein the nut-locking portion has a hole formed therein configured to mate with an outer surface of the nut, wherein a shape of the hole prevents the nut from rotating.

13. The anti-rotation device of claim 1, wherein:
the electrical connector pair is a coaxial connector pair; and
the anti-rotation device is configured to prevent de-coupling of the coaxial connector pair.
